(19) United States
(12) Patent Application Publication
(10) Pub. No.: US 2026/0233500 A1
(43) Pub. Date: Aug. 13, 2026

(54) MULTI-LAYERED COLORED SURFACE PROTECTION FILMS

(71) Applicant: DelStar Technologies, Inc., Alpharetta, GA (US)

(72) Inventors: Susan Blake, Greenfield, MA (US); Jeffrey Pratt, Orange, MA (US)

(21) Appl. No.: 19/530,796

(22) Filed: Feb. 5, 2026

Related U.S. Application Data
(60) Provisional application No. 63/755,342, filed on Feb. 7, 2025.

(51) Int. Cl. B32B 27/08; B32B 27/30; B32B 27/40; B32B 37/15

(52) U.S. Cl. CPC B32B 27/08; B32B 27/304; B32B 27/40; B32B 37/153; B32B 2250/03; B32B 2307/4026; B32B 2307/412; B32B 2327/06; B32B 2375/00; B32B 2571/00

(57) ABSTRACT

Multi-layer surface protection films for use as a coating for surfaces on a wide range of applications, such as automobiles, wind turbine blades, appliances, electronic displays, mobile devices, and the like. The surface protection films comprise a first layer comprising a pigment or dye and having first and second opposing surfaces, a second layer comprising thermoplastic polyurethane (TPU) in contact with the first surface of the first layer and an adhesive adjacent the second surface of the first layer. The TPU may be extruded onto the colored first layer to increase the durability of the colored layer while maintaining equivalent or superior performance to conventional colored protective films.

### CROSS-REFERENCE TO RELATED APPLICATIONS

This application claims the benefit of U.S. Provisional Application Serial No. 63/755,342, filed February 7, 2025, the complete disclosure of which is incorporated herein by reference for all purposes.

### TECHNICAL FIELD

This description generally relates to surface protection films and more particularly to multi-layered colored films for use in protecting exterior surfaces, such as painted or bare surfaces.

### BACKGROUND

Surface protection films provide a shield for bare or painted surfaces, such as metal, glass, and plastic, that are exposed to extreme conditions to aid in preventing damage from abrasion, chipping, chemicals, and mechanical and environmental wear. Desirable characteristics of such surface protection films include optical clarity, a high gloss surface, high and low temperature flexibility, conformability to three-dimensional surfaces, abrasion, and impact resistance. In addition, it is desirable that the films are easy to install and are cost-effective.

Colored polyvinyl chloride (PVC) films are widely used in the automotive industry, particularly for vehicle exterior applications such as wraps, decals, trim elements, and protective films. These films offer a range of benefits, such as enhanced aesthetics, UV protection, weather resistance, and cost-effectiveness compared to traditional paint.

While PVC colored films offer numerous advantages, such as easy application and cost-effectiveness, they are not as durable as traditional automotive paint, primarily due to their susceptibility to UV degradation, environmental stresses, physical impacts, and limited resistance to certain chemicals. In addition, as the PVC film ages, the flexibility of the material may decrease, causing it to become brittle or prone to cracking. This is especially common in areas where the film is subjected to constant bending, stretching, or flexing (like on curved body panels or bumpers).

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Surface protection films are provided herein. The surface protection films may be used as a protective coating for painted or unpainted surfaces in a wide range of applications. The surface protection films described herein are easy to use and compatible with commercial adhesive systems. Further, the surface protection films have excellent abrasion and impact resistance to provide users with a durable layer of protection for the interior or exterior surfaces of vehicles, aircraft and marine vessels, windows, signs and billboards, wind turbine blades and/or consumer electronics, such as appliances, electronic displays, mobile devices, and the like.

The surface protection films described herein provide improved durability, abrasion resistance, and environmental stability while maintaining optical clarity and design flexibility. The layered construction enhances resistance to ultraviolet radiation, mechanical wear, and environmental exposure, enabling long-term protection for interior and exterior surfaces. In addition, the films are compatible with conventional manufacturing processes and commercial adhesive systems, facilitating efficient production and ease of installation. The lightweight structure further reduces material usage while maintaining protective performance, making the films suitable for a wide range of industrial, transportation, and consumer applications.

In one aspect, a surface protection film comprises a first layer comprising a colorant and having first and second opposing surfaces. The film further comprises a second layer comprising thermoplastic polyurethane (TPU) in contact with the first surface of the first layer and an adhesive adjacent the second surface of the first layer. The TPU layer increases the durability of the colored layer while maintaining equivalent or superior performance to conventional colored protective films.

In certain embodiments, the adhesive is in contact with the second surface of the first layer.

In embodiments, the first and/or second layers are substantially optically transparent. In one embodiment, first layer is substantially optically transparent and second layer comprises one or more colorants, such as a pigment, pigment dispersion or dye. In another embodiment, the second layer is substantially optically transparent and the first layer comprises one or more colorants, such as a pigment, pigment dispersion or dye. In yet another embodiment, both first and second layers comprise one or more colorants, such as a pigment, pigment dispersion or dye

The second layer may be extruded or cast/calendared onto the first layer. Alternatively, the first layer may be extruded or cast/calendared onto the second layer.

In embodiments, the TPU comprises an aliphatic thermoplastic polyurethane (ATPU). In an exemplary embodiment, the TPU comprises an aliphatic, polycaprolactone-based thermoplastic polyurethane.

In embodiments, the film has a total thickness and the first layer has a thickness of about 5% to about 50%, or about 10% to about 20% of the total thickness. In an exemplary embodiment, the second layer has a thickness of about 1 mil to about 12 mils.

The colorant may comprise a pigment or dye that includes any suitable material, including but not limited to, organic pigments, inorganic pigments, metallic pigments, pearlescent pigments, solvent dyes, acid dyes, direct dyes, UV-stable pigments, fluorescent pigments and dyes, thermochromic and photochromic pigments and combinations thereof. In embodiments, the pigment or dye comprises about 10 wt% to about 35 wt% of the first layer.

The first layer may comprise any suitable material, including but not limited to, polyolefins, styrenic polymers, polyamides (nylon), polycarbonate (PC), polyurethane (PU), polyvinyl chloride (PVC), acrylics, such as polymethyl methacrylate (PMMA), polyoxymethylene (POM), thermoplastic olefins (TPO), acetates, such as ethylene-vinyl acetate (EVA), polyethylene terephthalate (PET), polyetheretherketone (PEEK), silicone-based polymers, polyvinylidene fluoride (PVDF), polytetrafluoroethylene (PTFE), cellulose acetate and combinations thereof.

In embodiments, the surface protection film further comprises a carrier layer in contact with the second surface of the first colored layer. The carrier layer may include any suitable material, such as synthetic polymers, including PU, PET, PVC, TPO, polypropylene (PP), PMMA, silicone-based polymers, PTFE, cellulose (e.g., silicon-coated paper, Kraft paper, Glassine paper, saturated paper, coated paper, heavy-weight paper, thermal paper, PE-coated paper, parchment paper) and combinations thereof.

In other embodiments, the adhesive is disposed within the carrier layer. In other embodiments, the adhesive is in contact with the carrier layer. The adhesive may include any suitable adhesive, such as acrylic-based adhesives, silicone-based adhesives, PU-based adhesives, rubber-based adhesives, hot-melt adhesives, pressure sensitive adhesives (PSA), solvent-based adhesives, water-based adhesives and combinations thereof. In an exemplary embodiment, the adhesive comprises PSA. Also optionally, a release layer is positioned on the outer surface of the PSA layer or the carrier layer.

In another aspect, a surface protection film comprises a first layer comprising a thermoplastic resin and a colorant and having first and second opposing surfaces, a second layer comprising thermoplastic polyurethane (TPU) in contact with the first surface of the first layer and an adhesive adjacent the second surface of the first layer.

The thermoplastic resin may include any suitable material, including but not limited to, polyolefins, styrenic polymers, polyvinyl chloride (PVC), polyamides (nylons), polycarbonate (PC), PET, polyoxymethylene (POM), PMMA, polyetheretherketone (PEEK), polyvinylidene fluoride (PVDF), PTFE, cellulose acetate and combinations thereof.

In an exemplary embodiment, the thermoplastic resin comprises polyvinyl chloride (PVC). The TPU layer may be extruded onto the first layer to increase the durability of the colored PVC layer while maintaining equivalent or superior performance to conventional colored protective films.

In embodiments, the first and/or second layers are substantially optically transparent.

The second layer may be extruded or cast/calendared onto the first layer. Alternatively, the first layer may be extruded or cast/calendared onto the second layer.

In embodiments, the TPU comprises an aliphatic thermoplastic polyurethane (ATPU). In an exemplary embodiment, the TPU comprises an aliphatic, polycaprolactone-based thermoplastic polyurethane.

In embodiments, the film has a total thickness and the first layer has a thickness of about 5% to about 50%, or about 10% to about 20% of the total thickness. In an exemplary embodiment, the second layer has a thickness of about 1 mil to about 12 mils.

In embodiments, the colorant comprises a pigment or dye in about 10 wt% to about 35 wt% of the first layer.

In embodiments, the surface protection film further comprises a carrier layer in contact with the second surface of the first colored layer. The carrier layer may include any suitable material, such as synthetic polymers, cellulose and combinations thereof.

In certain embodiments, the adhesive is disposed within the carrier layer. The adhesive may include any suitable adhesive, such as a pressure sensitive adhesive (PSA). Also optionally, a release layer is positioned on the outer surface of the PSA layer.

In another aspect, a surface protection film comprises a first layer comprising polyurethane (PU) and a colorant and having first and second opposing surfaces, a second layer comprising thermoplastic polyurethane (TPU) in contact with the first surface of the first layer and an adhesive adjacent the second surface of the first layer.

In embodiments, the PU in the first layer comprises any suitable PU or TPU formed by extrusion or solvent/emulsion casting. In an exemplary embodiment, the first layer comprises an aliphatic thermoplastic polyurethane (ATPU), such as an aliphatic, polycaprolactone-based thermoplastic polyurethane.

In embodiments, the first and/or second layers are substantially optically transparent.

The second layer may be extruded or cast/calendared onto the first layer. Alternatively, the first layer may be extruded or cast/calendared onto the second layer.

In embodiments, the second layer comprises an aliphatic thermoplastic polyurethane (ATPU). In an exemplary embodiment, the second layer comprises an aliphatic, polycaprolactone-based thermoplastic polyurethane.

In embodiments, the film has a total thickness and the first layer has a thickness of about 5% to about 50%, or about 10% to about 20% of the total thickness. In an exemplary embodiment, the second layer has a thickness of about 1 mil to about 12 mils.

In embodiments, the colorant comprises a pigment or dye in about 10 wt% to about 35 wt% of the first layer.

In embodiments, the surface protection film further comprises a carrier layer in contact with the second surface of the first colored layer. The carrier layer may include any suitable material, such as synthetic polymers, cellulose and combinations thereof.

In certain embodiments, the adhesive is disposed within the carrier layer. The adhesive may include any suitable adhesive, such as a pressure sensitive adhesive (PSA). Also optionally, a release layer is positioned on the outer surface of the PSA layer.

In another aspect, a surface protection film for use with an automobile is provided. In another aspect, an exterior part for a vehicle is provided comprising any of the films described above. In another aspect, a wind turbine blade is provided comprising any of the films described above. In yet another aspect, an electronic display is provided comprising any of the films described above.

The recitation herein of desirable objects which are met by various embodiments of the present description is not meant to imply or suggest that any or all these objects are present as essential features, either individually or collectively, in the most general embodiment of the present description or any of its more specific embodiments.

### BRIEF DESCRIPTION OF THE DRAWINGS

FIG. 1 is a side-view of a multi-layer surface protection film; and

FIG. 2 is a side-view of another embodiment of a multi-layer surface protection film.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Surface protection films are provided herein. The surface protection films may be used as a coating for painted or unpainted surfaces in a wide range of applications, including but not limited to, protection of the interior or exterior surfaces of vehicles, aircraft and marine vessels, windows, signs and billboards, wind turbine blades and/or consumer electronics, such as appliances, electronic displays, mobile devices, and the like.

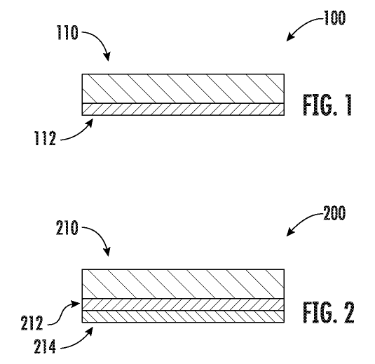

Referring now to FIG. 1, a surface protection film 100 comprises a first layer 112 and a second layer 110. In some embodiments, the layers 110, 112 are positioned on each other, as described herein, without the use of an intermediate adhesive layer. In one embodiment, the layers 110, 112 are compatible for co-extrusion and are affixed without an adhesive layer by co-extrusion of the layers. In other embodiments, layer 110 is extruded or cast onto layer 112. Second layer 110 may be extruded or cast/calendared onto first layer 112. Alternatively, first layer 112 may be extruded or cast/calendared onto the second layer 110.

In embodiments, the first and/or second layers 110, 112 are substantially optically transparent. In one embodiment, first layer 112 is substantially optically transparent and second layer 110 comprises one or more colorants, such as a pigment, pigment dispersion or dye (discussed below). In another embodiment, second layer 110 is substantially optically transparent and first layer 112 comprises one or more colorants, such as a pigment, pigment dispersion or dye. In yet another embodiment, both first and second layers 110, 112 comprise one or more colorants, such as a pigment, pigment dispersion or dye

Second layer 110 comprises a thermoplastic polyurethane (TPU). In embodiments, second layer 110 comprise a TPU resin. The TPU resin is produced by the polyaddition reaction between a diisocyanate and one or more polyols or long-chain diols, a chain extender or short-chain diol, and a diisocyanate. The TPU is a linear segmented block copolymer composed of hard and soft segments. The soft segment may be a polyether, polyester, or polycaprolactone, which provides flexibility and elastomeric character of the TPU. The hard segment (aromatic or aliphatic) is constructed from a chain extender and isocyanate. In some embodiments, the hard segment is based on an aliphatic isocyanate. In one embodiment, the TPU resin comprises an aliphatic thermoplastic polyurethane (ATPU). In an exemplary embodiment, the TPU comprises an aliphatic, polycaprolactone-based thermoplastic polyurethane.

TPU compounds are commercially available. The ATPU resin may be an extrudable, UV stabilized weatherable grade such as those commercially available used to make surface protective films. Examples of suitable ATPU include KRYSTALGRAN® PN23-200, an aliphatic polycaprolactone-based TPU, available from Huntsman Corporation, The Woodlands, TX, U.S.A; MIRATHANE® A290, an aliphatic polyester-based TPU, Miracll Chemicals Co., Ltd., Yantai, Shandong, PRC; ELASTANE® ALR CLC93A-V, The Lubrizol Corporation, Wickliffe, OH, U.S.A; and the ELASTOLLANE® L Series 785 A10, an aliphatic ester-based TPU from BASF, Florham Park, NJ, U.S.A.

Other additives, stabilizers, such as a UV stabilizer, adhesion promoters, co-polymers, cross-linkers, and polymer blends may be included in the TPU resin to enhance performance of the film.

First layer 112 comprises a colorant, such as a pigment, pigment dispersion, or dye. The pigment or dye may comprise any suitable material, including but not limited to organic pigments (such as azo pigments, quinacridone pigments, phthalocyanine pigments, perylene pigments, diketopyrrolopyrrole pigments, isoindolinone pigments, anthraquinone pigments, and indigoid pigments), inorganic pigments (such as titanium dioxide, iron oxides, chromium oxide, cobalt blue, ultramarine pigments, zinc oxide, and cerium oxide), metallic pigments (such as aluminum, copper, bronze, nickel, or stainless steel pigments), pearlescent and interference pigments (such as coated mica pigments and multilayer oxide pigments), solvent dyes, disperse dyes, acid dyes, direct dyes, fluorescent pigments and dyes, luminescent pigments, UV-stable pigments, thermochromic pigments, photochromic pigments, nanopigments, encapsulated pigments, and combinations thereof. The pigment may include plasticizer(s) and may include solvent(s).

In embodiments, the pigment or dye comprises about 2 wt% to about 50 wt%, or about 5 wt% to about 40 wt%, or about 10 wt% to about 35 wt%, or about 15 wt% to about 25 wt% of the first layer.

In some embodiments, the first layer 112 may further comprise one or more functional additives, including but not limited to stabilizers, antioxidants, UV absorbers, light stabilizers, heat stabilizers, lubricants, slip agents, release agents, dispersants, wetting agents, rheology modifiers, or combinations thereof.

In some embodiments, the first layer 112 may additionally or alternatively comprise a radiopaque material configured to enhance visibility under medical imaging, such as fluoroscopy or X-ray imaging.

In some embodiments, the first layer 112 may further comprise one or more bioactive agents, including but not limited to antimicrobial agents, antiseptics, anti-inflammatory agents, hemostatic agents, growth factors, or combinations thereof.

In some embodiments, the first layer 112 may comprise materials configured to modify electrical or thermal properties, such as electrically conductive fillers, electrically resistive fillers, thermally conductive fillers, or thermally insulating fillers.

n some embodiments, the first layer 112 may comprise materials configured to modify surface properties, including but not limited to hydrophobic agents, hydrophilic agents, lubricious coatings, adhesion promoters, or anti-fouling agents.

The first layer may comprise any suitable material, including but not limited to, polyolefins, styrenic polymers, polyamides (nylon), polycarbonate (PC), polyurethane (PU), polyvinyl chloride (PVC), acrylics, such as polymethyl methacrylate (PMMA), polyoxymethylene (POM), thermoplastic olefins (TPO), acetates, such as ethylene-vinyl acetate (EVA), polyethylene terephthalate (PET), polyetheretherketone (PEEK), silicone-based polymers, polyvinylidene fluoride (PVDF), polytetrafluoroethylene (PTFE), cellulose acetate and combinations thereof.

In one embodiment, the first layer comprises a thermoplastic resin. In an exemplary embodiment, the thermoplastic resin comprises polyvinyl chloride (PVC). The TPU layer may be extruded onto the first layer to increase the durability of the colored PVC layer while maintaining equivalent or superior performance to conventional colored protective films.

In another embodiment, the first layer comprises a polyurethane (PU). The PU may comprise any suitable PU or TPU formed by extrusion or solvent/emulsion casting In an exemplary embodiment, the first layer comprises an aliphatic thermoplastic polyurethane (ATPU), such as an aliphatic, polycaprolactone-based thermoplastic polyurethane.

In one embodiment, the first layer comprises PVC or a PVC dispersion. The PVC dispersion typically includes solvent(s), plasticizer(s), and/or stabilizer(s) for reducing or preventing detrimental effects caused by exposure to light and/or heat.

In certain embodiments, film 100 further includes an adhesive (not shown) in contact with the surface of first layer opposite second layer. The adhesive may include any suitable adhesive, such as acrylic-based adhesives, silicone-based adhesives, PU-based adhesives, rubber-based adhesives, hot-melt adhesives, pressure sensitive adhesives (PSA), solvent-based adhesives, water-based adhesives and combinations thereof. In embodiments, the adhesive is substantially optically transparent. In an exemplary embodiment, the adhesive comprises PSA.

In embodiments, the film 100 has a total thickness and the first layer 112 has a thickness of about 5% to about 50%, or about 10% to about 20% of the total thickness. In an exemplary embodiment, the second layer 110 has a thickness of about 1 mil to about 12 mils. The thickness of the total film and each of the first and second layers was measured with a micrometer in accordance with ASTM D69888-21.

In some embodiments, one or more of the first and second layers 110, 112 or the adhesive may have at least one additive added thereto. The additives are selected from a group including UV stabilizing agents, free-radical scavengers, cross-linking agents, thickeners, flow and leveling agents, rheology modifiers, surfactants, defoamers, dispersants, wetting agents, dyes, pigments, slip agents, co-solvents, water, isopropyl alcohol, or combinations thereof. Cross-linking agents can be added to the formulations to improve/modify the mechanical and chemical resistance properties of the particular layer(s).

Referring to FIG. 2, another embodiment of a surface protection film 200 comprises, a first colored layer 212, a second TPU layer 210 and a carrier layer 214 positioned in contact with the surface of first layer 212 opposite second layer 210. In certain embodiments, the adhesive is disposed within carrier layer or release liner 214.

The carrier layer 214 may include any suitable material, such as synthetic polymers, including PU, PET, PVC, TPO, polypropylene (PP), PMMA, silicone-based polymers, PTFE, cellulose (e.g., silicon-coated paper, Kraft paper, Glassine paper, saturated paper, coated paper, heavy-weight paper, thermal paper, PE-coated paper, parchment paper) and combinations thereof.

In some embodiments, the carrier layer 214 may comprises a dual surface film that has a rough, matte surface on one side and a glossy, smooth surface on the other side, combining differential surface roughness with high strength and durability, good dimensional stability, and chemical resistance. An example of a suitable carrier layer film 214 is a PET carrier. An example of a commercially available carrier film is Hostaphan^{®} MT44, Mitsubishi Chemical America, Inc.

In some embodiments, carrier layer 214 may include a release liner. When pressure sensitive adhesives are used, a release liner can be used to protect the adhesive from inadvertent contact with unintended surfaces. Any release liner suitable for the chosen adhesive can be used. For pressure sensitive adhesives, release liners can be coated papers or films, and super calendared paper, for example. Coating materials suitable for release liners include, for example, silicone-based and fluorine-based materials, or any other material that has the desired releasing properties, for example, waxes and carbamates.

The surface protection films 100, 200 can be applied to a variety of painted or bare surfaces, also referred to as substrates, and can be cut to the dimension of various surfaces. Examples of surfaces suitable for application of the surface protection film are vehicle bodies, windows, and aerospace vehicles, as well as a variety of other consumer goods, such as electronic screens and sporting goods, to protect the goods from wear. In one embodiment, the surface is a painted surface, and in some embodiments, the painted surface is an automobile.

A method of making a surface protective film according to the description is provided. First, a colored film (112, 212) is provided. The film may be passed through a suitable extrusion die onto a carrier layer or release liner (214). The carrier layer may include an adhesive or an adhesive may be applied to an outer surface of the carrier layer. The colored film and carrier layer may include any of the materials described above. In some embodiments, the carrier layer/release liner is not used and adhesive layer is affixed onto a surface of the colored film. In one embodiment, a surface protective film 100 is provided with an adhesive, such as a PSA layer affixed to a release liner. In some embodiments, the release liner is removed and the PSA is affixed to the surface protection film.

In some embodiments, a separate carrier layer may be provided adjacent the colored film. In these embodiments, the carrier layer is removed prior to applying the release liner/adhesive to the film.

A layer of TPU (110, 210) is then provided and a 3-Layer Coextrusion feedblock may be used to extrude the TPU layer onto the incoming substrate (i.e., the colored film and/or the carrier layer). The coextruded layers may then pass through a suitable extrusion die. The TPU layer may be extruded or cast/calendared onto colored film layer. Alternatively, colored film layer may be extruded or cast/calendared onto the TPU layer.

Although the method of making the layers of the surface protection film are described as being formed by extrusion, other methods known in the art can be used, such as calendaring and solvent casting. For example, the layers may be extruded sequentially, or two of the layers may be co-extruded, followed by sequential extrusion of the third layer. The film layers may be extruded using a multi-manifold coextrusion die or a coextrusion feedblock approach. The methods may also include laminating the multilayer film to one or more adhesive layers such that the one or more of the layers are “sandwiched” between an adhesive layer. Adhesives may include acrylics, polyurethanes, silicones, styrene-butadiene block copolymers, styrene-isoprene block copolymers, epoxies, cyanosacrylates, etc. In one embodiment, the adhesive may be a PSA. In other embodiments, one or more layers is solvent cast, which can be combined with subsequent co-extrusion or sequential extrusion of additional layers.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a surface protection film comprising: a first layer comprising a pigment or dye and having first and second opposing surfaces; a second layer comprising thermoplastic polyurethane (TPU) in contact with the first surface of the first layer; and an adhesive adjacent the second surface of the first layer.

A second embodiment is the first embodiment, wherein the second layer is substantially optically transparent.

A third embodiment is any combination of the above embodiments, wherein the second layer comprises an aliphatic thermoplastic polyurethane.

A 4^{th} embodiment is any combination of the above embodiments, wherein the second layer comprises an aliphatic, polycaprolactone-based thermoplastic polyurethane.

A 5^{th} embodiment is any combination of the above embodiments, wherein the second layer is extruded onto the first surface of the first layer.

A 6^{th} embodiment is any combination of the above embodiments, wherein the film has a total thickness and the first layer has a thickness of about 5% to about 50% of the total thickness.

A 7^{th} embodiment is any combination of the above embodiments, wherein the first layer thickness is about 10% to about 20% of the total thickness.

An 8^{th} embodiment is any combination of the above embodiments, wherein the second layer has a thickness of about 1 mil to about 12 mils.

A 9^{th} embodiment is any combination of the above embodiments, wherein the pigment or dye comprises about 10 wt% to about 35 wt% of the first layer.

A 10^{th} embodiment is any combination of the above embodiments, further comprising a carrier layer in contact with the second surface of the first colored layer.

An 11^{th} embodiment is any combination of the above embodiments, wherein the adhesive is disposed within the carrier layer.

A 12^{th} embodiment is any combination of the above embodiments, wherein the carrier layer is selected from a material consisting of synthetic polymers, cellulose and combinations thereof.

A 13^{th} embodiment is any combination of the above embodiments, wherein the adhesive comprises a pressure sensitive adhesive (PSA).

A 14^{th} embodiment is any combination of the above embodiments, further comprising a release liner in contact with the adhesive.

A 15^{th} embodiment is a surface protection film for use with an automobile and any combination of the above embodiments.

A 16^{th} embodiment is a wind turbine blade and any combination of the above embodiments.

A 17^{th} embodiment is an electronic display and any combination of the above embodiments.

An 18^{th} embodiment is a surface protection film comprising: a first layer comprising a thermoplastic resin and a pigment or dye and having first and second opposing surfaces; a second layer comprising thermoplastic polyurethane (TPU) in contact with the first surface of the first layer; and an adhesive adjacent the second surface of the first layer.

A 19^{th} embodiment is any combination of the above embodiments, wherein the thermoplastic resin comprises polyvinyl chloride (PVC).

A 20^{th} embodiment is any combination of the above embodiments, wherein the second layer is substantially optically transparent.

A 21^{st} embodiment is any combination of the above embodiments, wherein the second layer comprises an aliphatic thermoplastic polyurethane.

A 22^{nd} embodiment is any combination of the above embodiments, wherein the second layer comprises an aliphatic, polycaprolactone-based thermoplastic polyurethane.

A 23^{rd} embodiment is any combination of the above embodiments, wherein the film has a total thickness and the first layer has a thickness of about 5% to about 50% of the total thickness.

A 24^{th} embodiment is any combination of the above embodiments, wherein the first layer thickness is about 10% to about 20% of the total thickness.

A 25^{th} embodiment is any combination of the above embodiments, wherein the second layer has a thickness of about 1 mil to about 12 mils.

A 26^{th} embodiment is any combination of the above embodiments, wherein the pigment or dye comprises about 10 wt% to about 35 wt% of the first layer.

A 27^{th} embodiment is any combination of the above embodiments, further comprising a carrier layer in contact with the second surface of the first colored layer.

A 28^{th} embodiment is any combination of the above embodiments, wherein the adhesive is disposed within the carrier layer.

A 29^{th} embodiment is any combination of the above embodiments, wherein the carrier layer is selected from a material consisting of synthetic polymers, cellulose and combinations thereof.

A 30^{th} embodiment is any combination of the above embodiments, wherein the adhesive comprises a pressure sensitive adhesive (PSA).

A 31^{st} embodiment is any combination of the above embodiments, further comprising a release liner in contact with the adhesive.

A 32^{nd} embodiment is surface protection film for use with an automobile and any combination of the above embodiments.

A 33^{rd} embodiment is any combination of the above embodiments, wherein the second layer is extruded onto the first surface of the first layer.

A 34^{th} embodiment is a surface protection film comprising: a first layer comprising a polyurethane (PU) a pigment or dye and having first and second opposing surfaces; a second layer comprising thermoplastic polyurethane (TPU) in contact with the first surface of the first layer; and an adhesive adjacent the second surface of the first layer.

A 35^{th} embodiment is any combination of the above embodiments, wherein the PU in the first layer comprises a PU or TPU formed by extrusion or solvent/emulsion casting.

A 36^{th} embodiment is any combination of the above embodiments, wherein the TPU layer in the second layer is substantially optically transparent.

A 37^{th} embodiment is any combination of the above embodiments, wherein the TPU layer in the second layer comprises an aliphatic thermoplastic polyurethane.

A 38^{th} embodiment is any combination of the above embodiments, wherein the TPU layer in the second layer comprises an aliphatic, polycaprolactone-based thermoplastic polyurethane.

A 39^{th} embodiment is any combination of the above embodiments, wherein the film has a total thickness and the first layer has a thickness of about 5% to about 50% of the total thickness.

A 40^{th} embodiment is any combination of the above embodiments, wherein the first layer thickness is about 10% to about 20% of the total thickness.

A 41^{st} embodiment is any combination of the above embodiments, wherein the TPU layer has a thickness of about 1 mil to about 12 mils.

A 42^{nd} embodiment is any combination of the above embodiments, wherein the pigment or dye comprises about 10 wt% to about 35 wt% of the first layer.

A 43^{rd} embodiment is any combination of the above embodiments, further comprising a carrier layer in contact with the second surface of the first colored layer.

A 44^{th} embodiment is any combination of the above embodiments, wherein the adhesive is disposed within the carrier layer.

A 45^{th} embodiment is any combination of the above embodiments, wherein the carrier layer is selected from a material consisting of synthetic polymers, cellulose and combinations thereof.

A 46^{th} embodiment is any combination of the above embodiments, wherein the adhesive comprises a pressure sensitive adhesive (PSA).

A 47^{th} embodiment is any combination of the above embodiments, further comprising a release liner in contact with the adhesive.

A 48^{th} embodiment is any combination of the above embodiments, wherein the second layer is extruded onto the first surface of the first layer.

A 49^{th} embodiment is surface protection film for use with an automobile and any combination of the above embodiments.

What is claimed is:

1. A surface protection film comprising:
a first layer comprising a pigment or dye and having first and second opposing
surfaces;
a second layer comprising thermoplastic polyurethane (TPU) in contact with the first surface of the first layer; and
an adhesive adjacent the second surface of the first layer.

2. The surface protection film of claim 1, wherein the second layer is substantially
optically transparent.

3. The surface protection film of claim 1, wherein the second layer comprises an aliphatic, polycaprolactone-based thermoplastic polyurethane.

4. The surface protection film of claim 1, wherein the second layer is extruded onto the first surface of the first layer.

5. The surface protection film of claim 1, wherein the first layer comprises a material selected from the group consisting of polyolefins, styrenic polymers, polyamides (nylon), polycarbonate (PC), polyurethane (PU), polyvinyl chloride (PVC), acrylics, such as polymethyl methacrylate (PMMA), polyoxymethylene (POM), thermoplastic olefins (TPO), acetates, such as ethylene-vinyl acetate (EVA), polyethylene terephthalate (PET), polyetheretherketone (PEEK), silicone-based polymers, polyvinylidene fluoride (PVDF), polytetrafluoroethylene (PTFE), thermoplastic polyurethane (TPU), cellulose acetate and combinations thereof.

6. The surface protection film of claim 1, wherein the first layer comprises a thermoplastic resin.

7. The surface protection film of claim 1, wherein the film has a total thickness and the first layer has a thickness of about 5% to about 50% of the total thickness.

8. The surface protection film of claim 7, wherein the first layer thickness is about 10% to about 20% of the total thickness.

9. The surface protection film of claim 7, wherein the second layer has a thickness of about 1 mil to about 12 mils.

10. The surface protection film of claim 1, wherein the pigment or dye comprises about 10 wt% to about 35 wt% of the first layer.

11. The surface protection film of claim 1, further comprising a carrier layer in contact with the second surface of the first colored layer, wherein the carrier layer is selected from a material consisting of synthetic polymers, cellulose and combinations thereof.

12. A surface protection film comprising:
a first layer comprising a thermoplastic resin and a pigment or dye and having first
and second opposing surfaces;
a second layer comprising thermoplastic polyurethane (TPU) in contact with the first surface of the first layer; and
an adhesive adjacent the second surface of the first layer.

13. The surface protection film of claim 11, wherein the thermoplastic resin comprises polyvinyl chloride (PVC).

14. The surface protection film of claim 11, wherein the second layer is substantially
optically transparent.

15. The surface protection film of claim 11, wherein the second layer comprises an aliphatic, polycaprolactone-based thermoplastic polyurethane.

16. The surface protection film of claim 11, wherein the film has a total thickness and the first layer has a thickness of about 5% to about 50% of the total thickness.

17. The surface protection film of claim 16, wherein the first layer thickness is about 10% to about 20% of the total thickness.

18. The surface protection film of claim 16, wherein the second layer has a thickness of about 1 mil to about 12 mils.

19. The surface protection film of claim 11, wherein the pigment or dye comprises about 10 wt% to about 35 wt% of the first layer.

20. The surface protection film of claim 11, further comprising a carrier layer in contact with the second surface of the first colored layer.
